(19) United States
(12) Patent Application Publication
(10) Pub. No.: US 2012/0065893 A1
(43) Pub. Date: Mar. 15, 2012

(54) Method and apparatus for mitigating aviation risk by determining cognitive effectiveness from sleep history

(76) Inventor: Lynn Lee, Edgewater, MD (US)

(21) Appl. No.: 12/932,378

(22) Filed: Feb. 24, 2011

Related U.S. Application Data
(60) Provisional application No. 61/403,521, filed on Sep. 15, 2010.

(51) Int. Cl. G06F 19/00

(52) U.S. Cl. 702/19

(57) ABSTRACT

Method and apparatus for analyzing and managing fatigue primarily in but not limited to aviation occupations. The invention is adaptable to other occupations where assuring crew rest is critical. Graphical user interfaces (GUIs) allow for the insertion of sleep quantity, quality, and sleep interruptions over a number of days. The invention produces as an output the user's cognitive effectiveness ranging from high levels to critically low levels over a period of days.

### PRIORITY CLAIM UNDER 35 U.S.C. §119(e)

This patent application claims the priority benefit of the filing date of a provisional application, Ser. No. 61/403,521, filed in the United States Patent and Trademark Office on Sep. 15, 2010.

### STATEMENT OF GOVERNMENT INTEREST

The invention described herein may be manufactured and used by or for the Government for governmental purposes without the payment of any royalty thereon.

### BACKGROUND OF THE INVENTION

Fatigue has been implicated in 234 Air Force Class A mishaps, 27 of which have fatigue as a causal factor. As the Air National Guard continues to do more with less, it is vital to address the issue of fatigue in aviation operations. Sustained night-time combat operations must take fatigue into account—a single night without sleep with today's sophisticated aircraft can result in the loss of enough higher cognitive function to be fatal.

Between 1974 and 1992, 25% of the Air Force's night tactical fighter Class A accidents were attributed to fatigue. Over 12% of the Navy's total Class A accidents between 1977 and 1990 were thought to be the result of aircrew fatigue. Some reports have put the annual cost of fatigue-related Air Force mishaps as high as $45M, in addition to loss of lives. Note the crash of Korean Air flight 801 in which 228 people died; the near crash of China Airlines flight 006 in which two people were severely injured and other passengers were traumatized; or the accident involving American Airlines 1420 in which 11 people died. In each of these cases, crew fatigue from long duty periods and/or circadian factors have been implicated. (AFRL 2003-0059) Fatigue has been implicated in the Three Mile Island accident, Exxon Valdez environmental spill, and Chernobyl nuclear plant disaster.

NASA's Michael Mann, on the August 1999 Pilot Fatigue hearing to the Aviation Subcommitee, United States House of Representatives, testified that “ . . . pilot fatigue is a significant safety issue in aviation. Rather than simply being a mental state that can be willed away or overcome through motivation or discipline, fatigue is rooted in physiological mechanisms related to sleep, sleep loss, and circadian rhythms.” The FAA has reported that 21% of the error reports in NASA's confidential Aviation Safety Reporting System reference fatigue as a direct or indirect factor.

Fatigue drives breakdowns in crew resource management, shortens attention spans, increases susceptibility to spatial disorientation, and causes deadly microsleep events in crews on final approach and landing. Loss of performance due to sleep deprivation follows extremely closely with loss of performance from blood alcohol content; 24 hours wakefulness approximates to 0.10 BAC, a level considered legally drunk in most states. Yet our crews routinely take off in the evening and head across the Atlantic, landing a complex, multi-million dollar aircraft after being up all night.

A significant step in fatigue management is the introduction of computer-based tools which intend to predict human aviator performance. These automated tools employ human sleep models and their relationship to cognitive performance. To date, however, such tools' interfaces are difficult to use, time consuming, and do not address specific concerns for different airframes and mission profiles, and ultimately, are only as good as the sleep models employed.

The original implementation of prior art fatigue calculation methods was based on the Warfighter Fatigue Model paper written by Dr. Steven Hursh et al. The paper describes the Sleep, Activity, Fatigue, and Task Effectiveness (SAFTE) model. This can be thought of as a mathematical simulation based on a rising and falling reservoir. When an individual is awake, the reservoir slowly depletes, and when the individual is asleep, the reservoir level rises. In conjunction with this process, biological circadian rhythms are taken into account along with jet lag to determine an individual's effectiveness at any given time. However, the prior art SAFTE model by itself did not provide or consider any methods for automatically adding sleep to work schedule, it did not provide a method for introducing multiple sleep models representative of the different possible modes of sleep, nor did it provide a method for introducing and analyzing the influence of secondary factors such as stimulants, sleep inertia, etc on crew effectiveness.

Another prior art fatigue monitoring system called FAST did not provide any means for accounting the effects of jet lag, time zone shifts, or many other factors today deemed highly relevant.

There exists a great and urgent need for proactive, rather than reactive approaches to aircrew fatigue monitoring, allowing the military flight planner the flexibility to not only automatically factor the benefits of the additions of sleep into a work schedule, but also to account for the effects of various sleep quantity and quality and its affect upon aircrew cognitive effectiveness.

### OBJECTS AND SUMMARY OF THE INVENTION

One objective of this present invention is to provide a method and apparatus for mitigating aviation risk by logging and analyzing aircrew sleep quantity.

Another object of the present invention is to provide a method and apparatus for modeling various sleep modes.

Still another object of the present invention is to provide a method and apparatus for determining the affect of sleep interruptions.

Yet still another object of the present invention is to provide a method and apparatus that analyzes sleep quantity, quality, and interruptions and informs aircrew of their resultant cognitive effectiveness.

Briefly stated, the present invention provides a method and apparatus for analyzing and managing fatigue primarily in but not limited to aviation occupations. The invention is adaptable to other occupations where assuring crew rest is critical. Graphical user interfaces (GUIs) allow for the insertion of sleep quantity, quality, and sleep interruptions over a number of days. The invention produces as an output the user's cognitive effectiveness ranging from high levels to critically low levels over a period of days.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 depicts the process flow of the present invention.

FIG. 2 depicts the quality of sleep based on the number of sleep interruptions.

FIG. 3 depicts the initial start-up screen of the present invention's graphical user interface (GUI).

FIG. 4 depicts a dialog box for adding sleep segments.

FIG. 5 depicts a dialog box confirming the deletion of a sleep entry.

FIG. 6 depicts the process of editing sleep entries in the present invention's graphical user interface (GUI).

FIG. 7 depicts warning messages.

FIG. 8 depicts editing date and time on the present invention's graphical user interface (GUI).

FIG. 9 depicts the selection of the user's location the present invention's graphical user interface (GUI).

FIG. 10 depicts a graphical analysis of the user's cognitive effectiveness.

FIG. 11 depicts a warning that parameters missing or entered incorrectly.

FIG. 12 depicts a graphical analysis of the user's cognitive effectiveness with explanations of portions of the graph.

### DETAILED DESCRIPTION OF THE PREFERRED EMBODIMENT

The present invention is a method and apparatus for mitigating aviation risk and its features include the logging of sleep quantity, quality, and sleep interruptions over a number of days and the determination of aircrew cognitive effectiveness based thereon. While the primary motivation for the present invention is aircrew cognitive effectiveness, nothing in the present invention limits its application to aviation occupations.

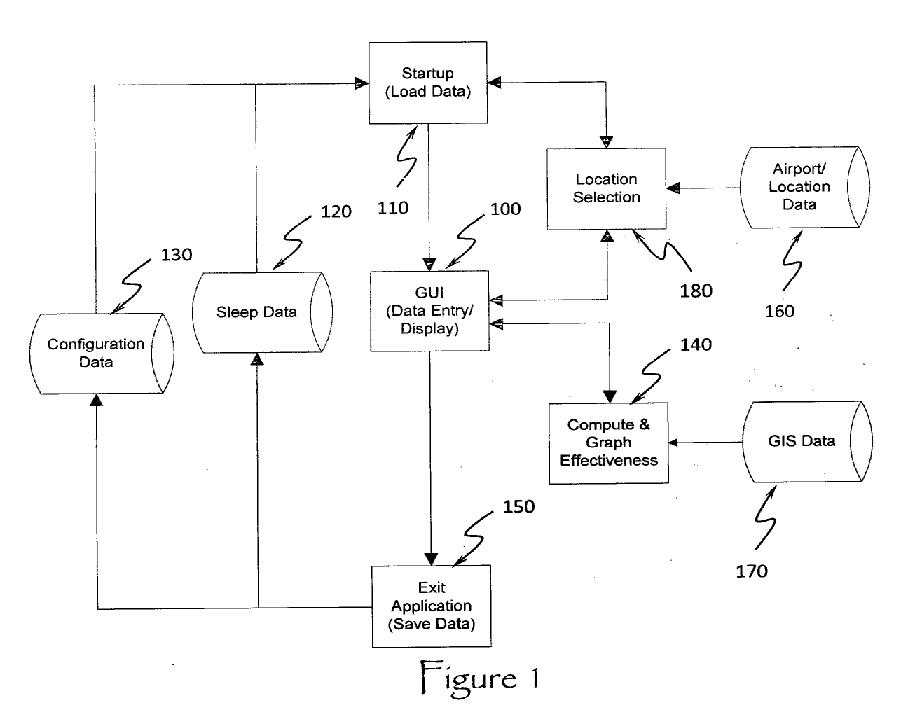

Referring to FIG. 1, the present invention utilizes a custom designed Windows-based graphical user interface (GUI) 100 to enter sleep data in tabular form. Data entry is similar to that employed in commonly assigned and copending U.S. patent application Ser. No. 12/806,259 filed on Jul. 30, 2010, the disclosure of which is incorporated herein by reference. Users estimate their quality of sleep for each sleep period entered. All analysis performed by the present invention is performed on local time rather than over multiple time zones. A user's location can be looked-up from either an airport ICAO code XML file or actual location 160 and then selected 180. A user's saved configuration data 130 and sleep 120 data is loaded at start-up 110. The present invention plots cognitive effectiveness 140 for the previous five days and for 18 hours after the current time, though, this time window can be variably set otherwise. As part of the analysis, the present invention provides explanations on the GUI itself about how to interpret the cognitive effectiveness graph. Data and all analysis is saved 150 upon exiting.

Still referring to FIG. 1 shows the process flow of the present invention from start up 110 to exit 150. To begin, all data is entered via the graphical user interface (GUI) 100. The data for the sleep diary (or log) entries will be stored in an XML file 120 eliminating the need to interface with any DBMS (Database Management System) as well as keeping the code extremely compact. The criteria for the selection of the data stored includes: ease of use, flexibility, elimination of external dependencies when possible. The use of XML provides for the simplest and most flexible data storage option. There is no dependency on external database management system (DBMS). The following is the data schema that the present invention uses to store and load configuration data into the Sleep Diary:

```
<SLEEP_CONFIG>
    <USER> </USER>
      <CURRENT_DATE></CURRENT_DATE>
      <ICAO> </ICAO>
      <ICAO_DESCRIPTION></ICAO_DESCRIPTION>
      <CUSTOM_LOCATION><CUSTOM_LOCATION />
      <COORDINATES> </COORDINATES>
    <NO_DAYS></NO_DAYS>
      </SLEEP_CONFIG>
```

With reference to the above data schema, USER refers to the name of the user. CURRENT_DATE refers to the local date/time when a particular schedule is created and is used to shift values when data is loaded. ICAO is the code for the airport where the user is geographically located. ICAO_DESCRIPTION is the description of the selected airport. CUSTOM_LOCATION is used in place of an ICAO if the user's current location does not exist in an airport file. NO_DAYS refers to the number of days to be graphed and analyzed by the present invention.

The following is the data schema that the present invention uses to store and load data into a sleep library:

```
<SLEEP_ENTRIES>
    <DATETIME> </USER>
      <HOURS></HOURS>
      <QUALITY></QUALITY>
  </SLEEP_ENTRIES>
```

where AMMO_ENTRIES refers to the name of the particular data set. DATE_TIME refers to the date and time of the start of a sleep cycle. HOURS refers to the amount of sleep for a specified date and time. QUALITY refers to the self-assessed value for the sleep obtained for a specified date and time.

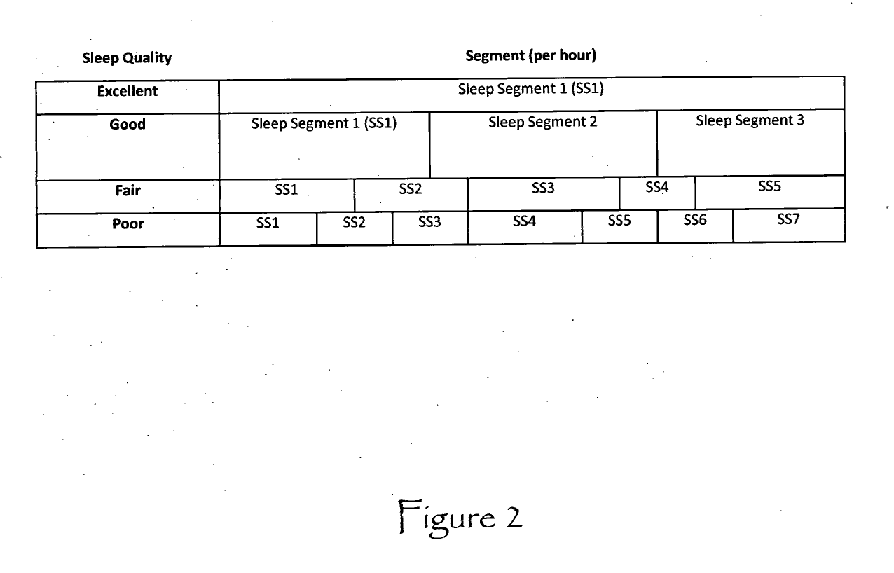

Referring to FIG. 2, a user estimates his or her sleep quality for each segment of sleep obtained according to four levels of quality having a numerical and color representation. Excellent sleep quality would be accorded a “0” and “Green” color; good sleep quality would be accorded a “1” and “Cyan” color; Fair sleep quality would be accorded a “2” and “Yellow” color; and Poor sleep quality would be accorded a “3” and “Red” color. A greater number of numerical and color designations are within the scope of the present invention and it need not be limited to four of each.

Still referring to FIG. 2, the sleep quality is use to determine how frequently sleep is “interrupted”. Each time sleep is interrupted, a 5 minute space is placed for the user to go back to sleep. Each level of quality is characterized by a corresponding increased number of “interruptions”. FIG. 2 additionally illustrates the number of occurrences of sleep interruptions in each hour of sleep. Specifically, no sleep interruption per hour correspond to “Excellent” sleep; two sleep interruptions per hour correspond to “Good” sleep; four sleep interruptions per hour correspond to “Fair” sleep; and six sleep interruptions per hour correspond to “Poor” sleep.

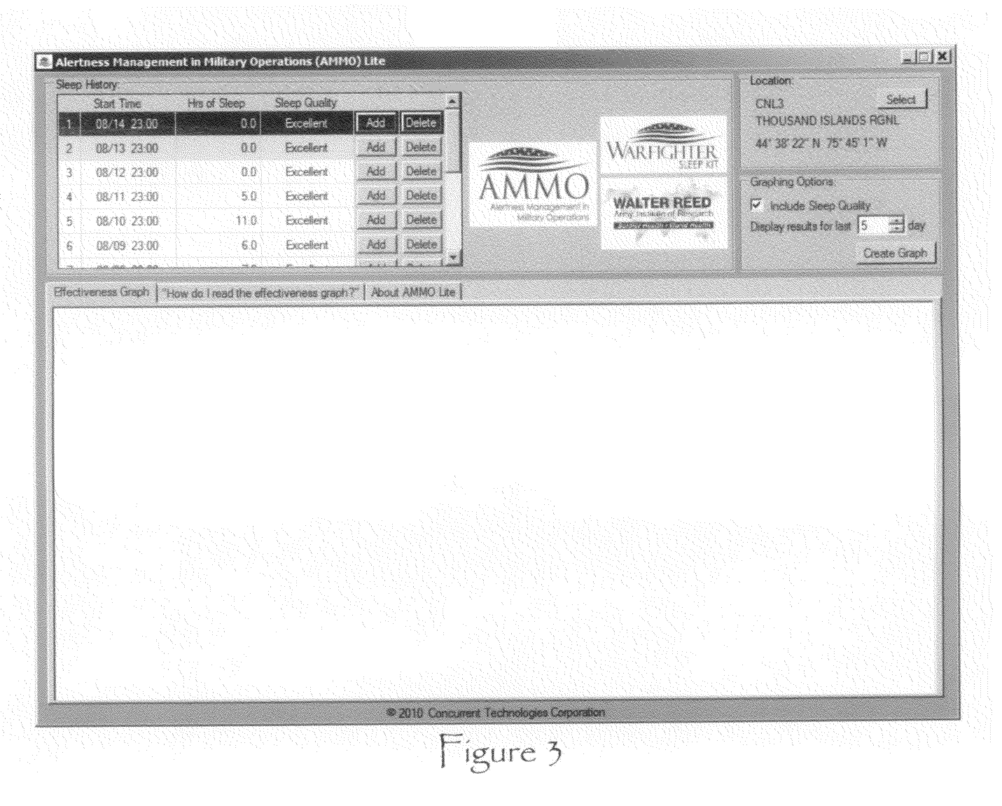

Referring to FIG. 3 (containing copyrighted material and is used herein with the permission of Concurrent Technologies) depicts the GUI entry of the user's sleep diary in tabular form. The user enters the amount of sleep time for each period of sleep with the minimum being zero hours up to a maximum of 24 hours. Several entries are required to initialize the sleep diary, specifically, five (5) days prior to the current date (as shown on the user's computer); the current date; and the day following the current date.

The present invention performs the calculation of sleep segments. A sleep segment (a portion of the sleep period based on quality) of sleep is computed by the present invention according to the following criteria. First, the invention establishes the number of interruptions using the sleep quality and number of hours according to

I=T*IPH

where
I=Number of interruptions
T=Sleep Time (in Hours)
IPH=interruptions per hour
   Next, the present invention determines the length of each sleep segment based on the number of interruptions during the sleep period according to

$$SS = \frac{T - ( m * I )}{I + 1}$$

where
SS=Sleep Segment
I=Number of interruptions
T=Sleep Time (in Hours)
m=constant value for length of interruption

Starting with the first sleep segment, each sleep segment is then added to the Activity list with a start time and the end time=start time+SS. The next start time within a given set is set to the previous end time+m (the constant value for the length of interruption).

Still referring to FIG. 3, the GUI provides the data entry form for the sleep diary. Upon initial startup, the user is prompted for the location (ICAO). The user will not be able to create the effectiveness graph until he/she selects a location (see 180, FIG. 1). All hours are initially set to zeros and the quality is set to excellent for the periods that are added to the sleep history (last five days, today and tomorrow).

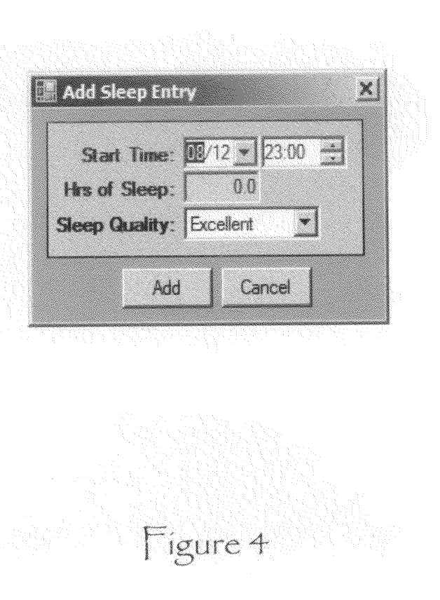

Referring to FIG. 4, the user is provided a list of sleep history entries that can be edited, deleted or amended with a new one based on the date of the highlighted entry. In the present embodiment of the invention, the Start Time can be any date between twenty-one (21) days ago thru one (1) day in the future. The hours of sleep (Hrs of Sleep) can be any value between 0.0 and 24.0 (one decimal place). The Sleep Quality values are one of the following: Excellent, Good, Fair, and Poor. The rating is used to adjust the cognitive effectiveness by inserting wake times during the defined period of sleep. The scope of present invention contemplates variability in the range of these parameters.

One embodiment of the present invention utilizes sleep entries for “today” as being designated by having a row with a tan background, and overlapping sleep periods having the first cell colored red (see FIG. 3). This assists in identifying potential issues before creating the graph.

Still referring to FIG. 4, the present invention permits the user to add a new entry based on the date of the currently selected row. The new row will have the same date/time but hours will be set to zero and quality set to excellent. In the following illustration, the “Add” button was pressed on item 2, resulting in a new row added (Item #3) with 0 hours and excellent sleep quality.

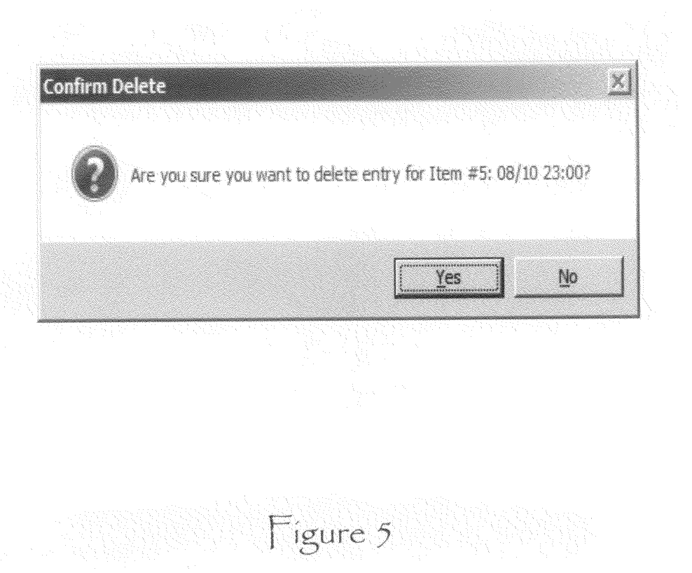

Referring to FIG. 5, the present invention permits the user to delete each row individually until there is only one row remaining. To delete a row, the user must select the “Delete” button from the row that is to be deleted and then select the “Yes” from the delete confirmation message.

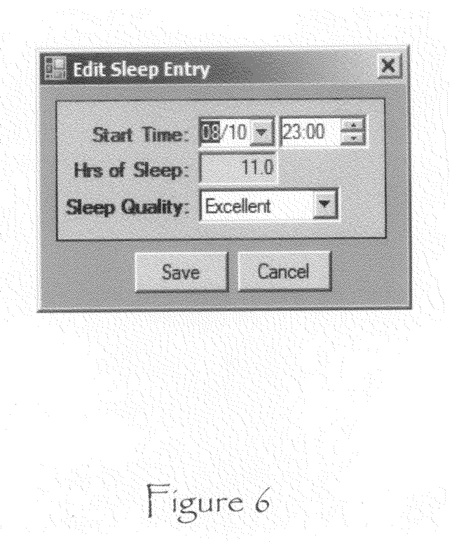

Referring to FIG. 6, the present invention permits the user to select a row to edit, and proceed to update the Start Time, Hrs of Sleep, and Sleep Quality. Upon completion of the editing, the user must press the save button in order to save the changes. After the user saves the changes, the present invention updates the sleep entry in the sleep history list with the new information.

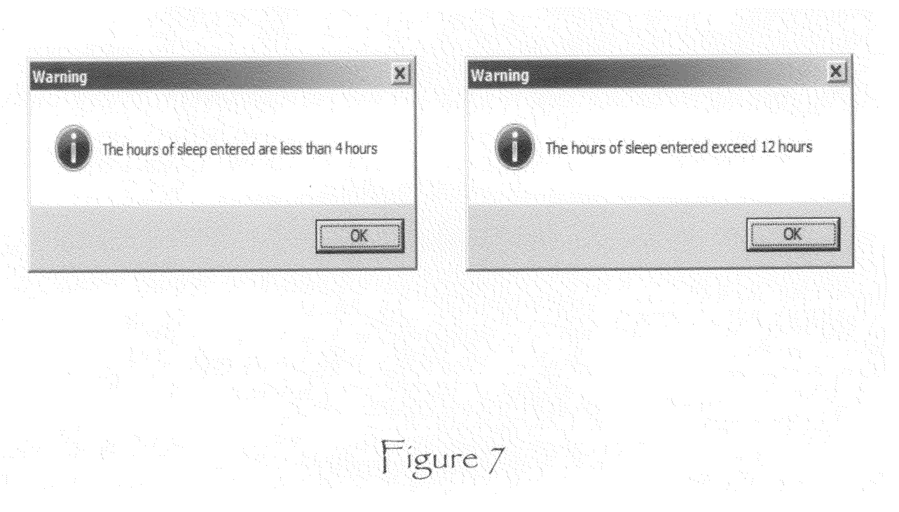

Referring to FIG. 7, if the user enters less than four hours or more than twelve hours for a sleep period, the present invention will display either of two corresponding warning messages to make them aware that they might have made an input error.

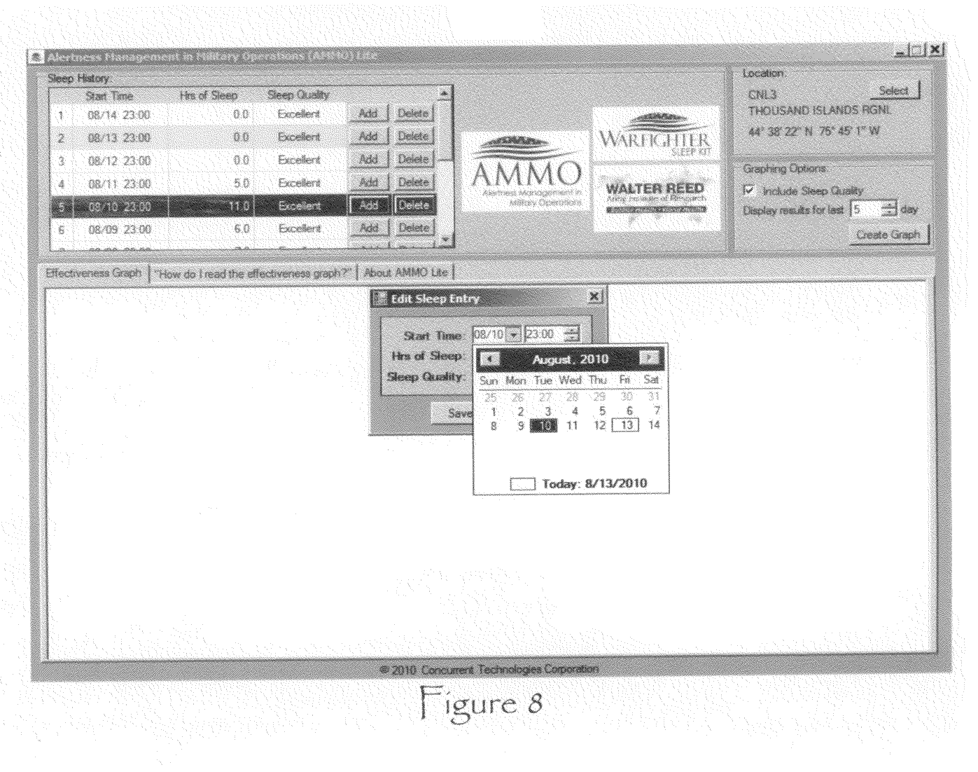

Referring to FIG. 8 (containing copyrighted material and is used herein with the permission of Concurrent Technologies), the present invention permits the user to select the date from a date picker which will only show the last twenty-one days (21), current date, and one day in the future. The user can also manually update the date and time.

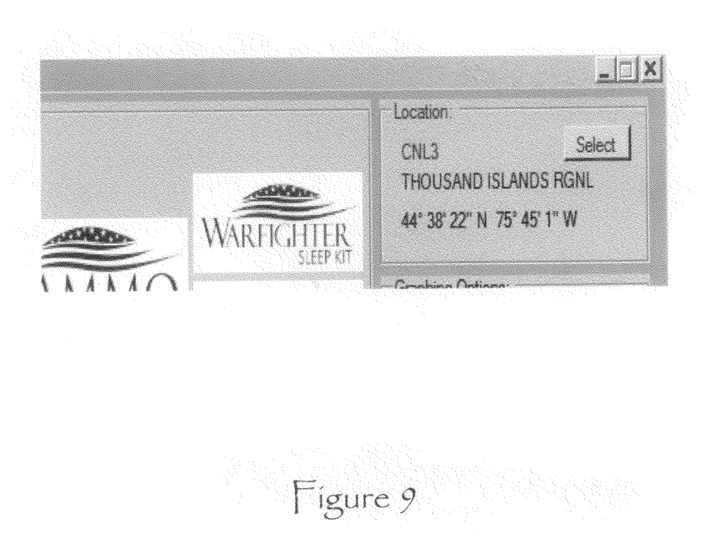

Referring to FIG. 9, the present invention permits the user to select a location that corresponds to their current location. In one embodiment of the present invention, this is done using the airport list to determine the latitude/longitude. On initial setup of the application the invention will prompt the user to select a location. The present invention permits user to either enter the ICAO code or partial name of location. Once the user either enters a valid ICAO in the first position or selects (double clicks) a location from the list, the invention will allow the user to proceed back to the diary entry screen by pressing the “OK” button. The user may close the window using the either cancel buttons on the selection window. The invention also allows the user to filter the list of locations, thereby reducing the list of selections. For example, if the user is searching for a location with the text of “5C”, a list of all the items with 5C either in the location or name will be displayed in a list for the user to select.

The present invention stores data for the airports in an XML file 160 and loads it into the application when the user changes their ICAO. The selected airport (ICAO) is stored in the data with the sleep diary information. The ICAO file is distributed with the application and the data includes the ID used within the present invention, the name, code and coordinates for the airport.

```
<AMMO>
  <Airport>
    <AirportID>12519</AirportID>
    <Name>REINA BEATRIX INTL</Name>
    <Latitude>12.501388549804688</Latitude>
    <Longitude>−70.015220642089844</Longitude>
    <ICAO>TNCA</ICAO>
  </Airport>
......
        <AMMO>
```

The sleep diary of the present invention automatically loads and saves data that has been entered. The user is not prompted about saving/loading data. The invention will load/save data from the last 21 days, the current date and one day in the future. Once the data is greater than 21 days, the data is disregarded. The 21 day limit is an adjustable parameter, however.

The present invention loads configuration and sleep history files during the startup 110. If the user changes graphing options or location, the changes are stored in the configuration file. All sleep history data is stored in the Sleep History file.

During the loading of the data 110, only data that is within a predetermined number of days, i.e., 21 days by default, from the current date will be loaded. If the “hours of sleep” value for a sleep entry is zero (0), the value will not be loaded.

After the data files are loaded, the invention will check to see if there are any missing dates for the past five (5) days, the current date, or one day in the future. If any of the dates don't have an entry, an entry with zero (0) hours will be created with the quality of “Excellent'.

The sleep history and configuration data is automatically saved upon exit 150. Only sleep history data that occurs between 21 days before the current date (by default), the current date, and one day in the future will be saved. Values that contain a zero (“0”) for the hours of sleep will not be saved.

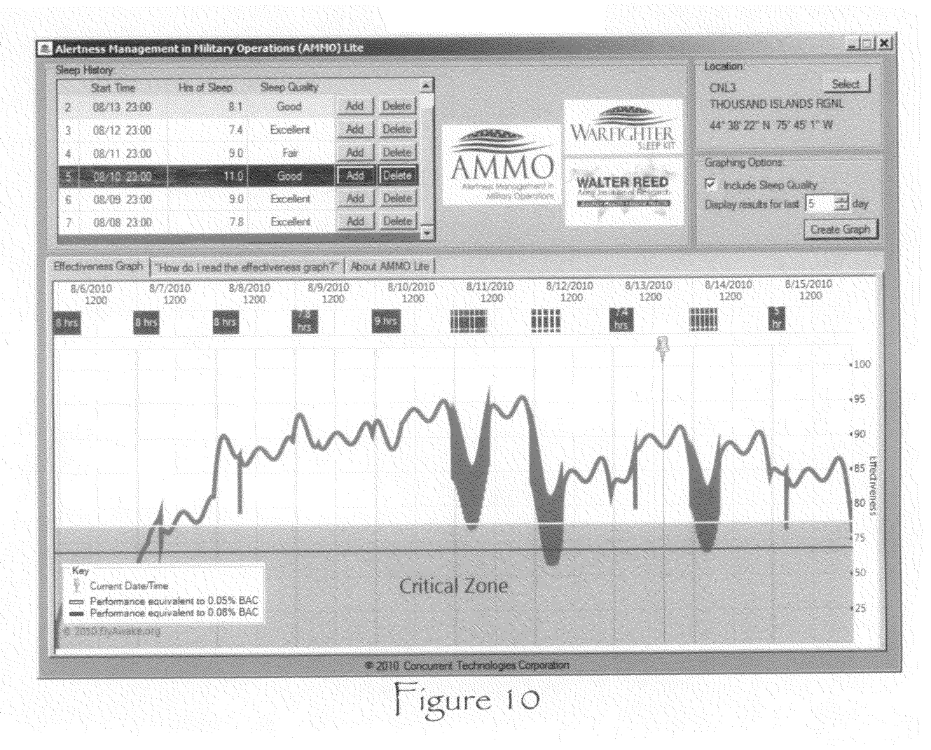

Referring to FIG. 10 (containing copyrighted material and is used herein with the permission of Concurrent Technologies), the effectiveness graphing tab on the present invention's GUI will display the effectiveness graph for sleep history the number of days indicated in the “Display results for last______days”. The user can elect to exclude the sleep quality from the graphing by removing the check from the checkbox.

If the user attempts to create a graph prior to selecting a location, the invention will display a message that a location must be selected before continuing. If the user selects the Sleep Quality option from the GUI, the Hours of Sleep will then be segmented and displayed as slices for the given time frame. If there are days without sleep entries, the graph will not have a defined sleep period for that day or days, and the effectiveness rate will be calculated accordingly.

The graphing options allow the user to include/exclude the Sleep Quality and to select the number of days to be included in the graph. Regardless of the number of days selected, three additional days are appended to the beginning of the schedule to provide a starting point for the graph that does not start at 0% for effectiveness. The number of days that the user can enter (by default) are limited to between five (5) and twenty-one (21). However, it is within the scope of the present invention to generate a graph for any number of days.

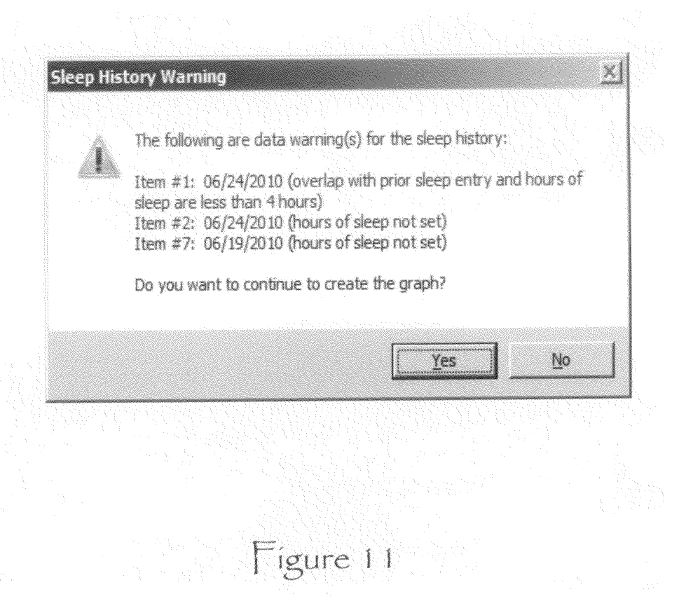

Referring to FIG. 11, to create the graph using the present invention, the user must select the “Create Graph” button from the GUI. The invention will determine if there are any potential issues (warnings) with the data in the sleep history entries. The user can elect to continue without changing or continue with graphing the output. If warnings are issued they would include overlap of time period; minimum value for hours exceeded; and maximum value for hours exceeded. It is within the scope of the present invention to compute a cognitive effectiveness utilizing any number of effectiveness algorithms. Commonly assigned and copending U.S. patent application Ser. No. 12/806,259 filed on Jul. 30, 2010 discloses several such methods including iSleep, Layover Sleep, and Fossil Sleep, which in turn utilize the Sleep, Activity, Fatigue, and Task Effectiveness (SAFTE) model for effectiveness computation.

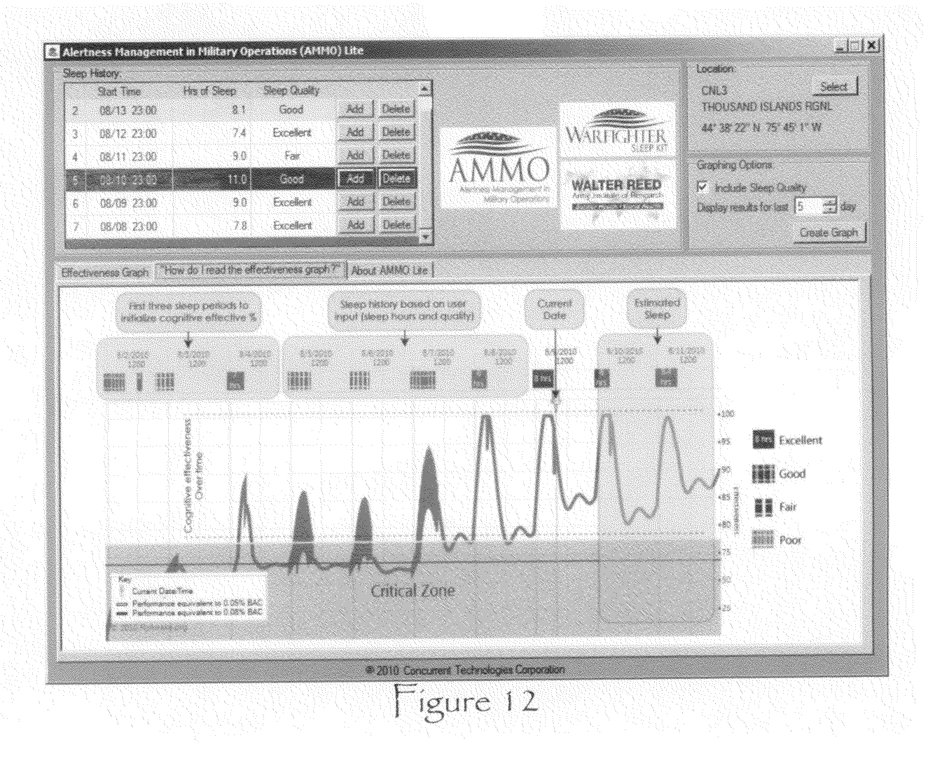

Referring to FIG. 12 (containing copyrighted material and is used herein with the permission of Concurrent Technologies), if a user selects the “How do I read the effectiveness graph?” button, the invention will display additional information on the graph including the critical regions and the cognitive effectiveness over time.

It is within the scope and spirit of the present invention and within the means of one skilled in the relevant art to extend the teachings of the present invention to other occupational fields.

What is claimed is:

1. An apparatus for mitigating aviation risk, comprising means for determining and analyzing aircrew cognitive effectiveness, comprising:
a computing means;
a software program comprising computer-executable instructions stored on a non-transitory computer readable storage medium, wherein said software program, when executed, comprises means for:
generating a user interface for data logging wherein said data comprises
sleep quantity;
sleep quality;
sleep interruptions; and
number of days over which sleep occurred;
creating a sleep activity list;
determining a cognitive effectiveness of said aircrew over said number of days; and
analyzing said cognitive effectiveness so as to determine critical levels of the same.

2. The apparatus of claim 1, wherein said sleep quality is estimated by the user according to the number of sleep interruptions experienced; and
wherein sleep quality is assigned a color code and a numerical code.

3. The apparatus of claim 2, wherein said color code is selected from the group of colors consisting of green, cyan, yellow, and red.

4. The apparatus of claim 1, wherein the number of said sleep interruptions is determined according to:
I=T*IPH
wherein
I is the number of sleep interruptions
T is the sleep time (in hours)
IPH is the number of sleep interruption per hour

5. The apparatus of claim 4, wherein the length of a sleep segment is determined according to:
$$SS = \frac{T - ( m * I )}{I + 1}$$
wherein
SS is the length of a sleep segment (in hours)
I is the number of sleep interruptions
T is the sleep time (in hours)
m is the constant value for the length of a sleep interruption

6. The apparatus of claim 5, wherein said means for creating a sleep activity list further comprises:
means for adding a start time of an initial sleep segment to a list in said GUI;
means for computing an end time of said initial sleep segment by adding said start time of said initial sleep segment to said sleep time of said initial sleep segment;
means for computing a start time of a successive sleep segment by adding said constant value for length of a sleep interruption to an end time of a previous sleep segment; and
means for computing an end time of a successive sleep segment by adding said start time of a successive sleep segment to said sleep time of said successive sleep segment.

7. The apparatus of claim 6, wherein any entry in said sleep activity list can be added, deleted, or edited from said GUI.

8. The apparatus of claim 7 wherein said means for creating a sleep activity list further comprises:
means for checking for missing dates among a plurality of past days;
means for checking for a missing date of the current day; and
means for checking for a missing date a plurality of days in the future.

9. The apparatus of claim 8 wherein said means for creating a sleep activity list further comprises means for entering a sleep entry with zero hours and excellent quality for any said missing date.

10. The apparatus of claim 9, wherein said means for determining a cognitive effectiveness of said aircrew over said number of days further comprises:
means for prompting user to select a location;
appending a user-determined number of days to the duration of a calculation so as to avoid a cognitive effectiveness calculation beginning with a zero percent effectiveness;
means for computing a cognitive effectiveness for each said sleep segment; and
means for graphing a sleep history for a user-selected number of days versus a cognitive effectiveness scale.

11. The apparatus of claim 10 wherein said means for analyzing said cognitive effectiveness further comprises:
means for alternately displaying or excluding sleep quality;
means for selecting a number of days to graph;
means for generating zones of varying sleep quality; and
means for generating critical regions in cognitive effectiveness.

12. A method for mitigating aviation risk by determining and analyzing aircrew cognitive effectiveness, comprising the steps of:
logging on a computer-based user interface, the following data:
sleep quantity;
sleep quality;
sleep interruptions; and
number of days over which sleep occurred;
creating a sleep activity list;
determining a cognitive effectiveness of said aircrew over said number of days; and
analyzing said cognitive effectiveness so as to determine critical levels of the same.

13. The method of claim 12, wherein said sleep quality is estimated by the user according to the number of sleep interruptions experienced; and
wherein sleep quality is assigned a color code and a numerical code.

14. The method of claim 13, wherein said color code is selected from the group of colors consisting of green, cyan, yellow, and red.

15. The method of claim 12, wherein the number of said sleep interruptions is determined according to:
I=T*IPH
wherein
I is the number of sleep interruptions
T is the sleep time (in hours)
IPH is the number of sleep interruption per hour

16. The method of claim 15, wherein the length of a sleep segment is determined according to:
$$SS = \frac{T - ( m * I )}{I + 1}$$
wherein
SS is the length of a sleep segment (in hours)
I is the number of sleep interruptions
T is the sleep time (in hours)
m is the constant value for the length of a sleep interruption

17. The method of claim 16, wherein said step of creating a sleep activity list further comprises the steps of:
adding a start time of an initial sleep segment to a list in said GUI;
computing an end time of said initial sleep segment by adding said start time of said initial sleep segment to said sleep time of said initial sleep segment;
computing a start time of a successive sleep segment by adding said constant value for length of a sleep interruption to an end time of a previous sleep segment; and
computing an end time of a successive sleep segment by adding said start time of a successive sleep segment to said sleep time of said successive sleep segment.

18. The method of claim 17, wherein any entry in said sleep activity list can be added, deleted, and edited from said GUI.

19. The method of claim 18 wherein said step of creating a sleep activity list further comprises the steps of:
checking for missing dates among a plurality of past days;
checking for a missing date of the current day; and
checking for a missing date a plurality of days in the future.

20. The method of claim 19 wherein said step of creating a sleep activity list further comprises the step of entering a sleep entry with zero hours and excellent quality for any said missing date.

21. The method of claim 20, wherein said step of determining a cognitive effectiveness of said aircrew over said number of days further comprises the steps of:
prompting user to select a location;
appending a user-determined number of days to the duration of a calculation so as to avoid a cognitive effectiveness calculation beginning with a zero percent effectiveness;
computing a cognitive effectiveness for each said sleep segment; and
graphing a sleep history for a user-selected number of days versus a cognitive effectiveness scale.

22. The method of claim 21 wherein said step of analyzing said cognitive effectiveness further comprises the steps of:
alternately displaying or excluding sleep quality;
selecting a number of days to graph;
generating zones of varying sleep quality; and
generating critical regions in cognitive effectiveness.
